(19) United States
(12) Patent Application Publication
(10) Pub. No.: US 2021/0128398 A1
(43) Pub. Date: May 6, 2021

(54) Multi-function Massage Roller

(71) Applicant: Stefan Arezina, Kitchener (CA)

(72) Inventor: Stefan Arezina, Kitchener (CA)

(21) Appl. No.: 17/084,770

(22) Filed: Oct. 30, 2020

Related U.S. Application Data
(60) Provisional application No. 62/929,152, filed on Nov. 1, 2019.

(51) Int. Cl. A61H 15/00; A61H 1/02

(52) U.S. Cl. CPC A61H 15/0092; A61H 1/0266; A61H 2015/0014; A61H 2201/1635; A61H 2201/1253; A61H 2201/164; A61H 2201/1671

(57) ABSTRACT

A multi-function massage roller is provided. The multi-function massage roller has a body with a vertical end wall opposing a sloped end wall. The sloped end wall has a frictional material disposed thereon. The frictional material defines a foot placement area that can be utilized to enable a user to place their foot on the device without it slipping. A lower end of the body includes a plurality of annular ridges thereon which also define a plurality of annular valleys. The vertical end wall of the body includes a plurality of apertures which are sized and shaped to receive a finger of the user therethrough.

### CROSS REFERENCE TO RELATED APPLICATIONS

This application claims the benefit of U.S. Provisional Application No. 62/929,152 filed on Nov. 1, 2019. The above identified patent application is herein incorporated by reference in its entirety to provide continuity of disclosure.

### BACKGROUND OF THE INVENTION

The present invention relates to massage equipment. More particularly, the present invention provides for a multi-function massage roller than can be utilized to perform massage therapy on various body parts and can also be utilized as a stable stretching aid.

Many people stretch in order to loosen their muscles and prevent delayed onset muscle soreness or other injuries that may result from engaging in active physical endeavors such as exercise, running, playing sports, and the like. Stretching is also an important task to loosen already tense muscles and provide relief from sore muscles. Unfortunately, many people forgo stretching routines and are at risk of injury, aches, pains, stiffness, and overall discomfort. People may opt for hiring a masseuse or enlisting another to massage them. A hired professional is not always available and may be costly over time. Enlisting another is not always an option, and the other person may also not always be available.

Devices have been disclosed in the known art that relate to massage equipment. These include devices that have been patented and disclosed in patent application publications. However, the devices in the known art have several drawbacks. Some devices require battery or other types of electrical power to provide vibration or other similar mechanical stimulation. Attuning this stimulation to an individual's needs to relax the muscles is often not easy and requires trial-and-error experimentation, as well as time. Some devices are useful for massaging one specific area of the body in a specific way, and do not provide the adaptability to be utilized according to the individual's present needs. Some devices are solid cylinders that are rolled against or on top of. These devices lack the ability to contour to an individual's muscles and bone structure, and also do not provide a stable surface on which a foot can be placed for stretching. Some people find that incorporating such devices into their daily routines is difficult as they are not portable and cannot be used in a desired orientation, such as while standing, lying down, or sitting. This difficulty can lead to poor and/or infrequent use.

The present invention substantially diverges in design elements from the known art and consequently it is clear that there is a need in the art for an improvement to existing massage devices. In this regard the present invention substantially fulfills these needs.

### SUMMARY OF THE INVENTION

In view of the foregoing disadvantages inherent in the known types of massage devices now present in the art, the present invention provides a multi-function massage roller than can be utilized to perform massage therapy on various body parts and can also be utilized as a stable stretching aid. The present multi-function massage roller comprises a body with a vertical end wall opposing a sloped end wall. The sloped end wall has a frictional material disposed thereon. The frictional material defines a foot placement area that can be utilized to enable a user to place their foot on the device without it slipping. A lower end of the body includes a plurality of annular ridges thereon which also define a plurality of annular valleys. The vertical end wall of the body includes a plurality of apertures which are sized and shaped to receive a finger of the user therethrough.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the multi-function massage roller.

FIG. 2 shows a rear view of an embodiment of the multi-function massage roller.

FIG. 3A shows a rear view of an embodiment of the multi-function massage roller in use.

FIG. 3B shows a side view of an embodiment of the multi-function massage roller in use.

### DETAILED DESCRIPTION OF THE INVENTION

Reference is made hereinto the attached drawings. Like reference numerals are used throughout the drawings to depict like or similar elements of the multi-function massage roller. For the purposes of presenting a brief and clear description of the present invention, a preferred embodiment will be discussed as used for the multi-function massage roller. The figures are intended for representative purposes only and should not be considered to be limiting in any respect.

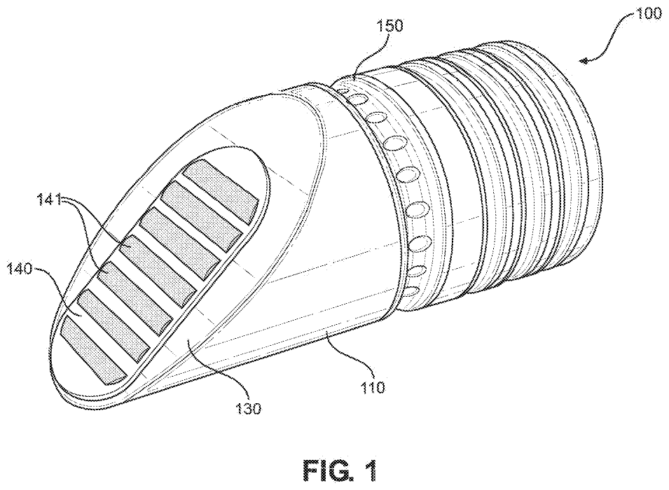

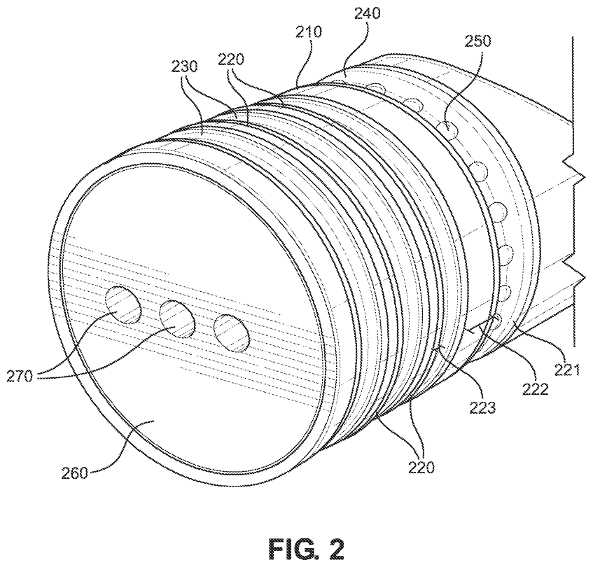

Referring now to FIG. 1, there is shown a front perspective view of an embodiment of the multi-function massage roller. The multi-function massage roller 100 comprises a body 110 with a vertical end wall (as shown in FIG. 2, 260) opposing a sloped end wall 130. In one embodiment, the body 110 is composed of a rigid material in order to prevent deformation as the device is pressed and rolled against parts of a user's body. The multi-function massage roller 100 is intended to be used in various massage therapies and stretching activities, and thus it is contemplated by this disclosure that the device is constructed in a manner to withstand heavy use in such activities and that the body 110 is able to withstand the forces employed in such activities including being resistant to compression and maintaining its general shape. It should be understood by one of ordinary skill in the art that some level of flexibility is also contemplated by this disclosure. In one embodiment, for example, the body 110 is composed of a rigid foam material. Such a material is able to provide a rigid and solid surface that can be utilized in massage and stretching activities, but is also able to provide some give and flexibility to provide a measure of comfort to the user when the device is being used in such a manner.

In various other embodiments, the body 110 is composed of a material such as Ethylene-vinyl acetate (EVA), Expanded Polypropylene Foam (EPP), and Polyethylene foams. EVA is also commonly known as expanded rubber or foam rubber and has been used as padding in equipment for various sports including ski boots and hockey pads. EVA is easy to work with while maintaining a high level of durability and comfort to the user. EPP is a closed-cell bead foam that provides properties such as impact resistance, a high strength-to-weight ratio, and can be 100% recyclable. Polyethylene foam is also a closed-cell foam and provides shock-absorbing properties as well as vibration dampening, and cushioning properties. In some embodiments, the body 110 can be colored and decorated with various materials such as a silicone wrapping 150. The silicone wrapping 150 not only provides aesthetic benefits, but also provides a different texture than other materials used in the body 110. In various embodiments, the silicone wrapping 150 can be a gel, a rigid layer, or a rubber-like layer.

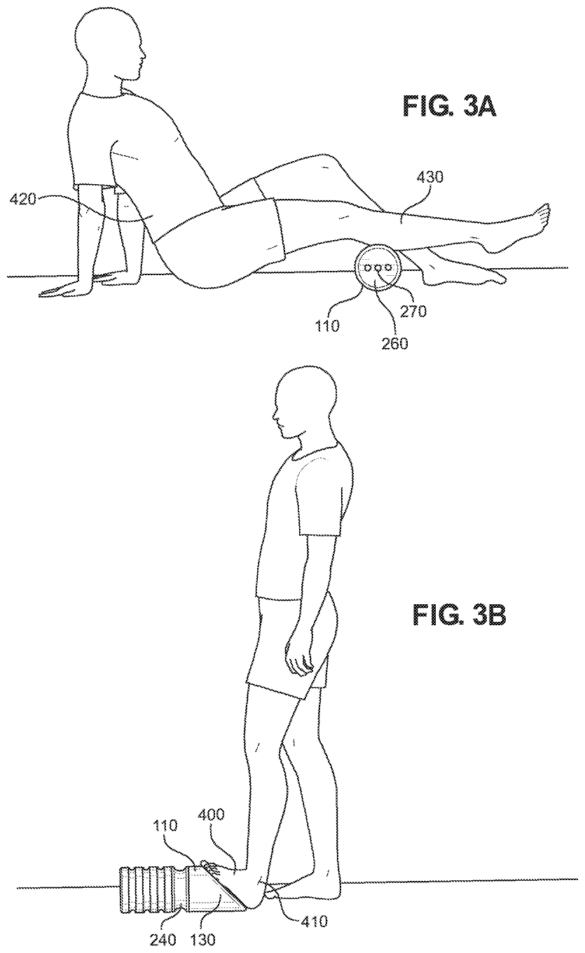

In the shown embodiment, the body 110 comprises a cylindrical shape. As one use of the present device is to roll the body 110 against the user's skin, and applying pressure thereto in order to provide a massage therapy, the cylindrical shape can be utilized to roll the exterior of the surface of the device while still maintaining the desired pressure and tactile stimulation. Other shapes of the body 110 are contemplated by the present disclosure, and some shapes, such as a box shape, can be utilized to provide corners and edges that may be desirable. In the shown embodiment, corners and edges are provided from the nature of the vertical end wall 260 and the sloped end wall 130. Such corners and edges can be utilized to provide greater pressure by utilizing a smaller surface area to contact the user's body. In one embodiment, an angle of the sloped end wall 130 is between thirty-four (34) and sixty-six (66) degrees. The sloped end wall can be utilized to provide a surface on which to stretch a portion of the user's body. In use, the user can position a foot on the sloped end wall, for example, and the angle of the sloped end wall 130 can aid in stretching exercises involving an ankle (as shown in FIG. 3B). In a further embodiment, the angle is thirty-five (35) degrees to provide a gentle angle at which the foot is held, while still holding the foot and ankle in a stretched position.

In various embodiments, a length of the body 110 is between eleven (11) and forty-one (41) inches. The multi-function massage roller 100 is a portable device that can be utilized to provide massage therapy to various parts of the user's body. In order to maintain its portability, the length of the device is kept to an easy to manage size which also provides for easy storage. Various lengths are contemplated as the device can be utilized by individuals with differing body sizes and types, as well as providing broad or fine coverage for the area in which the user desires to massage and/or stretch. Similarly, in various embodiments, a diameter of the body 110 is between four (4) and eight (8) inches. Such a range of diameters enable the device to closely match and mimic various contours of the user's body, such as a back of a knee or a neck.

The sloped end wall 130 further comprises a frictional surface 140 defining a foot placement area. In the shown embodiment, the frictional surface 140 includes a series of raised sections 141 to provide an anti-slip characteristic. The raised sections 141 enable a user to place their foot on the surface without the foot slipping off while performing stretching exercises. In some embodiments, the frictional surface 140 is integral to the sloped end wall 130, while in other embodiments, the frictional surface 140 is disposed on top of the sloped end wall 130. In some embodiments, the frictional surface 140 is a strip of material attached to the sloped end wall 130. In the shown embodiment, the frictional surface 140 covers only a portion of the sloped end wall 130, while in other embodiments the frictional surface 140 covers the entirety of the sloped end wall 130. In other embodiments, the frictional surface 140 and the raised sections 141 form a raised logo for the device.

Referring now to FIG. 2, there is shown a rear view of an embodiment of the multi-function massage roller. A lower end 210 of the body 110 includes a plurality of annular ridges 220 thereon. In the shown embodiment, each of the annular ridges 220 encircle an entirety of a circumference of the body 110. In this manner, when the body 110 is rolled and rotated against a user's skin, the annular ridges 220 maintain contact with the skin. Further, in the shown embodiment, the plurality annular ridges 220 is evenly spaced to provide a consistent surface and tactile stimulation. When a compressive force is applied to the body 110 from the sloped end wall, the annular ridges 220 may compress towards each other, such that the user may feel resistance from a complementary force relative to the compressive force. The space between the plurality of annular ridges 220 define a plurality of annular valleys 230. In the embodiments in which each of the annular ridges 220 encircle the entirety of the circumference of the body 110, the annular valleys 230 also encircle the entirety of the circumference of the body 110. Similarly, in some embodiments in which the plurality of annular ridges 220 is evenly spaced, the annular valleys 230 are also evenly spaced.

In the shown embodiment, a wide annular ridge 221 is disposed on the lower end 210 of the body 110. The space between the wide annular ridge 221 and the upper end 211 of the body 110 defines an annular channel 240. The annular channel 240 enables a user to accommodate bony landmarks in the user's body when utilizing the multi-function massage roller. In the shown embodiment, the lower end 210 of the body 110 further comprises the annular channel 240, and the annular channel 240 is disposed around the circumference of the body 110. Further, in the shown embodiment, a wide annular ridge width 222 is greater than an annular ridge width 223. In other embodiments, the ratios between the wide annular ridge width 222 and the annular ridge width 223 vary according to the needs of the user. Additionally, although the annular channel 240 in the shown embodiment is the last n a series of annular valleys 230, the present disclosure contemplates that the annular channel 240 can be located in the beginning or the middle of such annular valleys 230, in various embodiments.

In some embodiments, the annular channel 240 further comprises a plurality of dimples 250. In the shown embodiment, the plurality of dimples 250 is disposed around the circumference of the body. Further, in the shown embodiment, the plurality of dimples 250 is evenly spaced. Similar to the plurality of annular ridges 220, the plurality of dimples 250, as well as the annular channel 240, is configured to provide resistance when a force is applied to the body. In various embodiments, a depth of the plurality of dimples 250 is between one-tenth (0.1) and three and one-tenth (3.1) centimeters. Such a range in depths enables a user to experience different levels of resistance when portions of their skin are in contact with the dimples 250.

The vertical end wall 260 of the body comprises a plurality of apertures 270. The apertures 270 are sized and shaped to receive a finger of a user therethrough. The apertures 270 can thus enable the user to insert a single, or multiple fingers therethrough to provide the user with a more stable grip on the body. In various embodiments, an aperture diameter is between one-half (0.5) and three and a half (3.5) centimeters. Such a range of diameters can accommodate for different sized fingers of various users.

Referring now to FIGS. 3A and 3B, there are shown a rear view and a side view of an embodiment of the multi-function massage roller in use. A user can use the multi-function massage roller to perform massage therapy on various body parts and can also be utilized as a stable stretching aid. The sloped end wall 130, for example, can be utilized by placing a foot 400 on a frictional surface thereof, wherein the frictional surface aids in preventing the user's foot 400 from slipping on the sloped end wall 130. Through utilization of the sloped end wall 130, the user can stretch their foot 400 and ankle 410 by flexing the appropriate muscles. Such an exercise enables the user to easily stretch the joints in their foot at various angles. The use of the sloped end wall 130 can also allow the user to stretch their calves, toes, and associated body parts. The annular channel 240 can be utilized to accommodate and fit around bony landmarks in the user's body when the device is rolled or compressed against such landmarks. In the shown embodiment, the body 110 of the device is cylindrical foam which can be utilized as a traditional foam roller.

One use of the present device is to roll the body 110 against the user's skin and applying pressure thereto in order to provide a massage therapy. The cylindrical shape can be utilized to roll the exterior of the surface of the device while maintaining a constant desired pressure and tactile stimulation. Other shapes of the body 110 are contemplated by the present disclosure, and some shapes, such as a box shape, can be utilized to provide corners and edges that may be desirable. In the shown embodiment, corners and edges are provided by nature of the vertical end wall 260 and the sloped end wall 130. Such corners and edges can be utilized to provide greater pressure by utilizing a smaller surface area to contact the user's body. For example, corners of the present device can be utilized to perform active myofascial release techniques through a range of motions. The apertures 270 disposed in the vertical end wall 260 can be utilized by a person inserting at least one finger therethrough to create leverage to be used in stretching exercises for their hands, wrists, and forearms, as well as decompressing joints. In one use, the user may place their fingers through the apertures 270 and place the body 110 on a desired area, such as below their back 420, below their legs 430, or on the ground whereby the user may engage the sole of their foot 400 on the upper end of the body 110. In this way, the device can be utilized to perform massage therapy on various body parts and can also be utilized as a stable stretching aid.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multi-function massage roller, comprising:
a body with a vertical end wall opposing a sloped end wall;
the sloped end wall further comprising a frictional surface defining a foot placement area;
the vertical end wall comprising a plurality of apertures; and
wherein the plurality of apertures is sized and shaped to receive a finger of a user therethrough.

2) A multi-function massage roller, comprising:
a body with a vertical end wall opposing a sloped end wall;
the sloped end wall further comprising a frictional surface defining a foot placement area;
a lower end of the body includes a plurality of annular ridges thereon, thereby defining a plurality of annular valleys;
the vertical end wall comprising a plurality of apertures; and
wherein the plurality of apertures is sized and shaped to receive a finger of a user therethrough.

3) The multi-function massage roller of claim 2, wherein the body is composed of a rigid foam material.

4) The multi-function massage roller of claim 3, wherein the body is composed of a material selected from the group consisting of: Ethylene-vinyl acetate (EVA), Expanded Polypropylene Foam (EPP), and Polyethylene foams.

5) The mufti-function massage roller of claim 2, wherein the body comprises a cylindrical shape.

6) The mufti-function massage roller of claim 2, wherein an angle of the sloped end wall is between 34 and 66 degrees.

7) The multi-function massage roller of claim 7, wherein the angle of the sloped end wall is 35 degrees.

8) The multi-function massage roller of claim 2, wherein a length of the body is between 11 and 41 inches.

9) The multi-function massage roller of claim 2, wherein a diameter of the body is between 4 and 8 inches.

10) The multi-function massage roller of claim 2, wherein an aperture diameter is between 0.5 and 3.5 centimeters.

11) The multi-function massage roller aim 2, further comprising a silicone wrapping.

12) The multi-function massage roller of claim 2, wherein each of the annular ridges encircle an entirety of a circumference of the body.

13) The multi-function massage roller of claim 2, wherein the plurality of annular ridges is evenly spaced.

14) The multi-function massage roller of claim 2, wherein each of the annular valleys encircle an entirety of a circumference of the body.

15) The multi-function massage roller of claim 2, wherein the plurality of annular valleys is evenly spaced.

16) A multi-function massage roller, comprising
a body with a vertical end wall opposing a sloped end wall;
the sloped end wall further comprising a frictional surface defining a foot placement area;
a lower end of the body includes a plurality of annular ridges thereon, thereby defining a plurality of annular valleys;
the lower end of the body further comprising an annular channel disposed around a circumference of the body;
the vertical end wall comprising a plurality of apertures; and
wherein the plurality of apertures is sized and shaped to receive a finger of a user therethrough.

17) The multi-function massage roller of claim 17, wherein the annular channel further comprises a plurality of dimples.

18) The multi-function massage roller of claim 17, wherein the plurality of dimples is disposed around a circumference of the body.

19) The multi-function massage roller of claim 17, wherein the plurality of dimples is evenly spaced.

20) The multi-function massage roller of claim 17, wherein a depth of the plurality of dimples is between 0.1 and 3.1 centimeters.
